(19) United States
(12) Patent Application Publication
(10) Pub. No.: US 2024/0090487 A1
(43) Pub. Date: Mar. 21, 2024

(54) STORAGE DEVICE FOR CRAWLER HARNESS FISHING SYSTEM

(71) Applicant: Schupan & Sons, Inc., Kalamazoo, MI (US)

(72) Inventors: Robert E. Lynch, Portage, MI (US); Robert J. Richardson, Vicksburg, MI (US)

(21) Appl. No.: 18/069,268

(22) Filed: Dec. 21, 2022

Related U.S. Application Data
(60) Provisional application No. 63/376,478, filed on Sep. 21, 2022.

(51) Int. Cl. A01K 97/06

(52) U.S. Cl. CPC A01K 97/06; A01K 89/0165

(57) ABSTRACT

A storage device for a fishing lure includes a spool having a longitudinal axis extending between first and second ends. A flange extends radially from the first end of the spool and includes a circumferential edge extending between first and second sides. A slot extends radially from the edge toward the longitudinal axis. A recess extends radially from the edge between the first and second sides. The slot receives a line of the lure so that a connecting element at a first end of the line is disposed at the first side of the flange. The spool receives a length of the line so that the line is wrapped about the spool. The recess receives a hook at a second end of the line to secure the second end relative to the spool when the connecting element is disposed at the flange and the line is wrapped about the spool.

### CROSS REFERENCE TO RELATED APPLICATION

The present application claims the filing benefits of U.S. provisional application Ser. No. 63/376,478, filed Sep. 21, 2022, which is hereby incorporated herein by reference in its entirety.

### FIELD OF THE INVENTION

The present invention relates generally to fishing lures and systems and, more particularly, to crawler harnesses.

### BACKGROUND OF THE INVENTION

Trolling is a known method of fishing for walleye, lake trout, northern pike, and other species of fish. When trolling, a fisherman in a moving vessel places a fishing line and lure into the water such that the lure is configured to be presented to the fish at a desired depth. Lures vary in length, configuration, and effectiveness for use with different fish species and fishing conditions. Thus, a fisherman will often carry and use several different lures during a fishing expedition in an attempt to find the most optimal for the present conditions. However, lures, such as crawler harnesses and the like used in trolling, often become damaged and tangled between uses.

### SUMMARY OF THE INVENTION

A storage device for a fishing lure includes a spool. The spool has a longitudinal axis that extends between a first end of the spool and a second end of the spool. A flange is disposed at the first end of the spool and extends radially from the spool at the first end. The flange includes a first side and a second side opposite the first side and separated from the first side by a thickness of the flange. A circumferential edge of the flange extends between the first side and the second side. A radially extending slot extends from the circumferential edge of the flange and toward the longitudinal axis of the spool. The flange has a hook receiving recess or hole or receiving portion that extends radially from the circumferential edge of the flange between the first side and the second side. The slot is configured to receive a leader line of a fishing lure so that a connecting element at a first end of the leader line is disposed at the first side of the flange. The spool is configured to receive a length of the leader line between the first end of the leader line received at the slot and a second end of the leader line opposite the first end so that the leader line is wrapped about the spool. When the connecting element is disposed at the first side of the flange and the leader line is wrapped about the spool, the recess or hole or receiving portion receives a hook at the second end of the leader line to secure the second end of the leader line relative to the spool.

Optionally, a storage system for a fishing lure includes the storage device that is configured to retain the fishing lure disposed thereat, and a mounting rack that includes a plate and a peg extending from the plate. When the storage device is stored at the mounting rack, the storage device is rotatably disposed along the peg of the mounting rack. A cylindrical passage extends through the spool and along the longitudinal axis between the first end and the second end of the spool, and the peg is received along the cylindrical passage to store the storage device at the mounting rack.

Optionally, a retention feature is disposed along the cylindrical passage. The peg may include a compressible protrusion that compresses as the peg is moved along the cylindrical passage and the compressible protrusion moves along the cylindrical passage toward the retention feature, and expands when the compressible protrusion is at the retention feature to secure the storage device along the peg.

These and other objects, advantages, purposes and features of the present invention will become apparent upon review of the following specification in conjunction with the drawings.

### BRIEF DESCRIPTION OF THE DRAWINGS

FIG. 1 shows schematic views of example crawler harnesses;

FIG. 2 is a perspective view of a fishing lure storage device configured to receive and retain one or more crawler harnesses;

FIG. 3 is side view of the fishing lure storage device of FIG. 2;

FIG. 4 is a top view of the fishing lure storage device of FIG. 2;

FIG. 4A is an enlarged view of the region A of FIG. 4, showing the retention slot formed through the flange of the fishing lure storage device;

FIG. 5 is a side view of the fishing lure storage device of FIG. 2;

FIG. 5A is an enlarged view of the region A of FIG. 5, showing the hook capture formed along the circumferential edge of the flange of the fishing lure storage device;

FIGS. 6 and 7 are enlarged views of the fishing lure storage device, showing the retention slot anchoring and end of a lure thereat;

FIG. 8 is an enlarged view of the fishing lure storage device, showing a hook engaged with the hook capture;

FIG. 9 shows swivel connection elements that, when attached at the end of a fishing lure, engage the retention slot to anchor the fishing lure at the fishing lure storage device;

FIG. 10 is a sectional view of another fishing lure storage device having a retention feature along the passage that is configured to receive a mounting pin of a mounting rack;

FIG. 11 is a sectional view of the fishing lure storage device of FIG. 10, shown disposed at the mounting rack;

FIG. 12A is a sectional view of the fishing lure storage device and mounting pin of FIG. 10 spaced from one another;

FIG. 12B is a sectional view of the fishing lure storage device and mounting pin of FIG. 10, with the mounting pin received along the passage of the fishing lure storage device;

FIG. 13 is a perspective view of the mounting rack and mounting pin of FIGS. 12A and 12B;

FIG. 14 is a perspective view of the mounting rack of FIGS. 12A and 12B, with a fishing lure storage device mounted at the mounting pin; and

FIG. 15 is a sectional view of another fishing lure storage device configured to receive a plurality of fishing lures.

### DESCRIPTION OF THE PREFERRED EMBODIMENTS

When trolling, a fisherman typically attaches a lure, such as a crawler harness or rig, to the end of a fishing line and presents the lure at a desired depth in water as the fisherman moves the lure through the water. These lures vary in length and include a variety of components and/or attachments intended to attract different species of fish and provide different functionality to the fisherman. Thus, the fisherman will typically carry and/or store several different lures and swap the lure attached to the end of the fishing line to optimize their chances of attracting and catching fish.

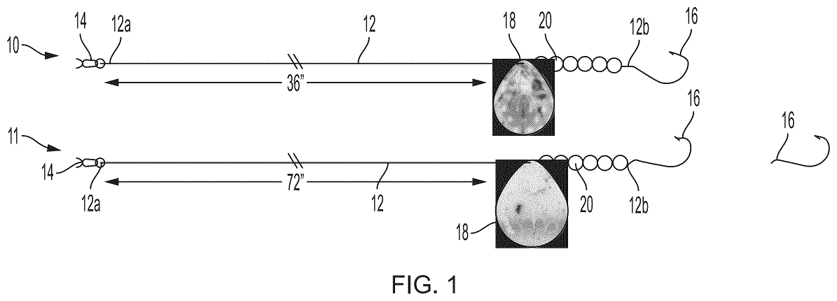

That is, lures used in trolling may vary greatly. As shown in FIG. 1, these lures (a first lure 10 and a second lure 11 are shown) typically include a length of line or thin wire referred to as a leader 12. The leader 12 includes, at a first end 12a of the leader 12, a connecting element 14, such as a loop of the leader line 12 or terminal tackle element (e.g., a metal swivel device such as a barrel swivel or snap swivel or the like), for simple connection to a main fishing line coming from a fishing rod. One or more hooks 16 are connected to the second end 12b of the leader 12 opposite the first end 12a. Various components and/or attachments may be added along the length of the leaders 12, such as attractors 18 and spacers 20.

Attractors 18 and spacers 20 are used to entice or gain the attention of fish during the trolling process. Spacers 20 are primarily used to keep the attractors 18 away from the hooks 16 to prevent interference from the attractor 18 with the hook 16 and any bait being used. For example, the spacers 20 may include a series of beads or washers disposed along the leader 12 between the attractor 18 and the hook 16. The spacers 20 may also provide a similar function as the attractors by providing color, shape, and sometimes vibration.

The attractors 18 are colored and shaped to attract nearby fish. For example, attractors 18 attached along the leader 12 may include blades 18. The blade 18 spins as the lure moves through the water. The blade 18 may be attached to the leader 12 using a device called a clevis. The clevis is designed to retain the blade 18 and allows the blade 18 to rotate about the axis of the leader 12 without damaging the leader 12.

The length of different lures, from connecting element 14 to hook 16, may vary greatly. For example, a lure may be 3 inches, 12 inches, 36 inches, or 72 inches long or longer. In the illustrated embodiment, the first lure 10 includes a 36 inch long leader 12 and the second lure 11 includes a 72 inch long leader 12. Furthermore, lures may include different combinations, configurations, and numbers of attractors 18, spacers 20, and hooks 16 disposed along the leaders 12. Finding the best combination of color, shape, blade size, and other attractants necessitates changing lures frequently while fishing, having multiple lures on hand, and storage of the lures, such as on the fishing vessel or in a fishing tackle box.

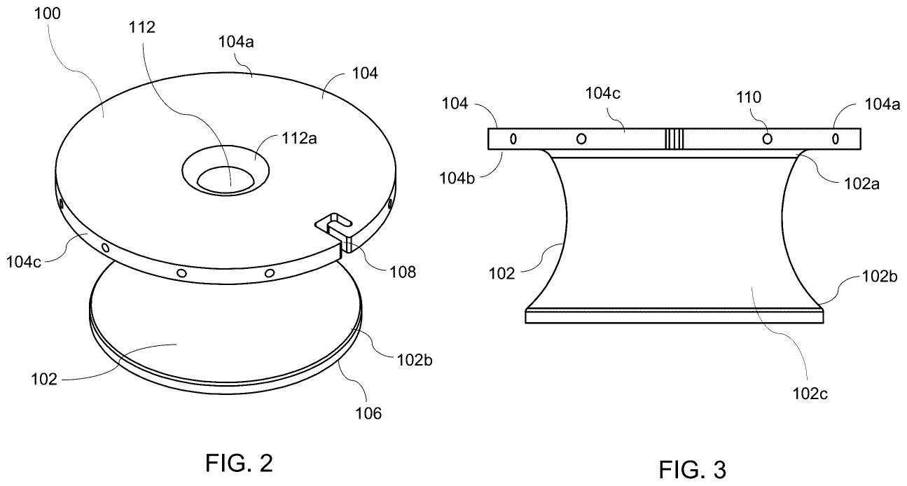

As shown in FIGS. 2-8, a storage device 100 for a fishing lure (such as of the types of fishing lures 10, 11 shown in FIG. 1) is configured to receive and retain the lure such that the connecting element 14 is received at and retained by a retention slot or element 108 of the storage device 100, the leader 12 extending from the connecting element 14 is wrapped about or disposed around a spool 102 of the storage device 100, and the one or more hooks 16 at the opposite end of the leader 12 are received at and retained in respective hook capture holes or slots or receiving portions 110 of the storage device 100. Thus, the first end 12a of the lure or rig is anchored by the retention slot 108, the length of the lure or rig is wrapped around the spool 102, and the second end 12b of the lure or rig is anchored at the hook capture 110 to maintain tension in the lure and secure the lure at the storage device 100. The storage device 100 provides an easy to use storage solution for one or more lures to organize and prevent tangling of lures and allows for ease of winding and unwinding of the lures from the storage device, especially when paired with a mounting rack or rod that supports the storage device (or a plurality of storage devices) and allows for free rotation of the storage device relative to the mounting rack or rod (so as to ease winding or unwinding of the lure from the spool of the storage device).

Thus, the storage device 100 includes a spool 102 configured so that the lure may wrap around the spool 102 when retained at the storage device 100. The spool 102 has a first end 102a and a second end 102b at an opposite end of the spool 102 from the first end 102a, where the body or outer surface 102c of the spool extends between the first and second ends. In the illustrated embodiment, the body 102c is tapered toward a central region of the spool to accommodate different length lures wrapped around the spool 102. In other words, the outer diameter of the spool 102 at the central region between the first end 102a and the second end 102b is less than the outer diameters of the spool at the first and second ends. A tapering or contoured profile extends between the respective first and second ends and the central region. The larger outer diameters at the first and second ends may be equal to one another or the outer diameter at one end may be larger than the outer diameter at the other end. Optionally, the body portion of the spool may comprise any suitable shape, such as a conical body or a cylindrical body with a generally uniform outer diameter between the ends of the spool.

A planar flange or rim 104 is disposed at and extends radially from the first end 102a of the spool 102, such as perpendicular to a longitudinal axis of the spool 102. The flange 104 includes a first or outer side or surface 104a that faces away from the spool body 102c. A second or inner side or surface 104b of the flange 104 that is opposite the first side 104a faces the body 102c and second end 102b of the spool and is spaced from the first side 104a of the flange 104 by a thickness of the flange 104. A circumferential side surface 104c of the flange 104 extends between the first side 104a and the second side 104b of the flange 104. The flange 104 has an outer diameter that is greater than an outer diameter of the spool 102 at the first end 102a. Thus, when the lure is wrapped around the spool 102, the flange 104 extends beyond the outer surface 102c of the spool 102 and prevents the lure from pulling off the spool 102 at the first end 102a.

In the illustrated embodiment, a smaller lip or rim 106 is disposed at and extends from the spool 102 at the second end 102b. That is, the lip 106 extending from the second end 102b of the spool 102 has a smaller outer diameter than the flange 104, but still has an at least slightly larger outer diameter than the spool 102 at the second end 102b to preclude the lure from pulling off the spool 102 at the second end 102b. Optionally, a second flange that is similarly configured to the flange 104 may be disposed at the second end 102b of the spool 102. The flanges may be attached at the respective ends of the spool or may be integrally formed with the spool, such as via a common plastic injection molding process or an additive manufacturing process (e.g., 3D printing).

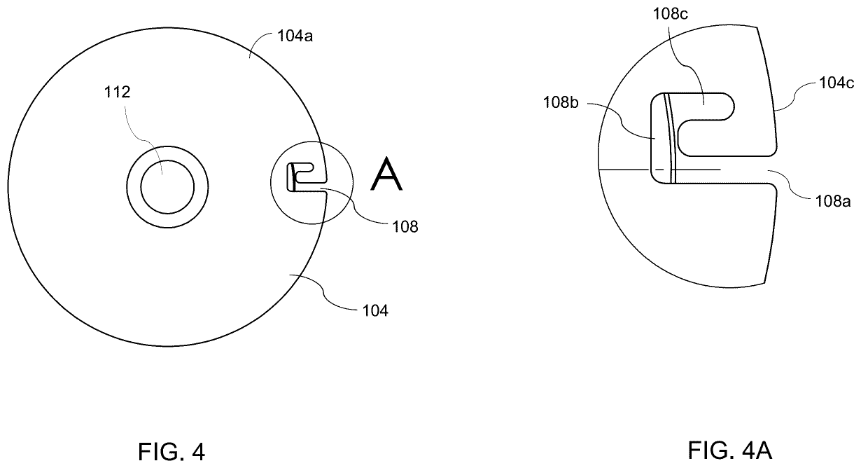

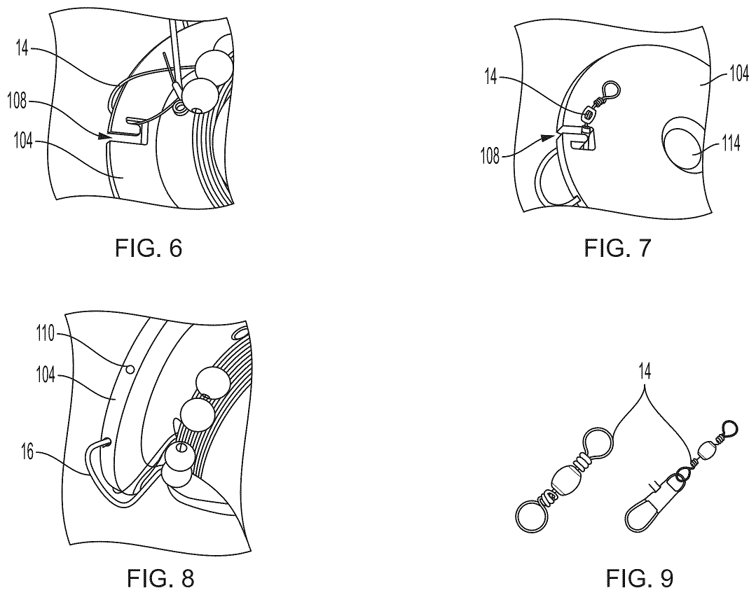

As shown in FIGS. 4, 4A, 6, 7, and 10, the retention slot 108 is formed through the flange 104 and is configured to receive the first end 12a of the lure when the lure is disposed at the storage device 100. That is, the retention slot 108 is configured to hold a loop (FIG. 6) or to retain the terminal tackle element (FIG. 7) or other fishing equipment 14 (e.g., swivels or snap swivels, as shown in FIG. 9) disposed at the first end 12a of the lure to secure the first end 12a of the lure at the flange 104 and prevent interference between the equipment at the first end 12a and other components disposed along the leader 12 when wrapping or unwrapping the leader 12 about the spool 102.

The retention slot 108 extends from the outer edge 104c of the flange toward the center of the storage device 100 and through the thickness of the flange 104, and is configured to retain the connecting element 14 at the retention slot 108 or first side 104a of the flange 104 while allowing the leader 12 to pass through the retention slot 108 to the second side 104b and spool 102. That is, the leader 12 may thread through the retention slot 108, with the width or dimension of the retention slot 108 preventing the equipment 14 from pulling through the retention slot 108. For example, and as shown in FIG. 7, a width of the retention slot 108 is wide enough for the leader 12 to pass through, but not the swivel element 14 disposed at the end 12a of the lure.

As shown in FIG. 4A, the retention slot 108 may be a J-shaped channel to limit or preclude unintentional dislodgement of the leader from the retention slot and/or so that a loop 14 at the end 12a of the lure may catch the flange 104 at the retention slot 108 to retain the first end 12a of the lure at the retention slot 108. That is, the J-shaped retention slot 108 may include a first portion 108a extending from an opening at the circumferential edge 104c of the flange toward the center of the storage device 100. A second portion 108b extends substantially perpendicularly to the first portion 108a at an end of the first portion 108a opposite the opening at the circumferential edge 104c. A returning third portion 108c extends substantially perpendicularly to the second portion 108b at an end of the second portion 108b opposite the first portion 108a and toward the circumferential edge 104c. The third portion 108c does not extend all the way from the second portion 108b to the edge 104c. In other words, a portion of the flange 104 extends over or closes the retention slot 108 to provide the J shape, thus allowing a loop 14 to be caught on a portion of the flange 104 at the retention slot 108. Optionally, the retention slot 108 may comprise any suitable shape to catch or retain the lure, such as a smooth J-shape, or a retention slot with a plurality of hooks or catches for retaining a plurality of lures, such as a W-shaped or Y-shaped slot. Thus, as the lure is wrapped around the spool 102, the first end 12a of the lure is anchored at the retention slot 108, such as via the loop 14 wrapping around a portion of the flange 104 at the retention slot 108 or the terminal tackle element being too wide to pass through the retention slot 108.

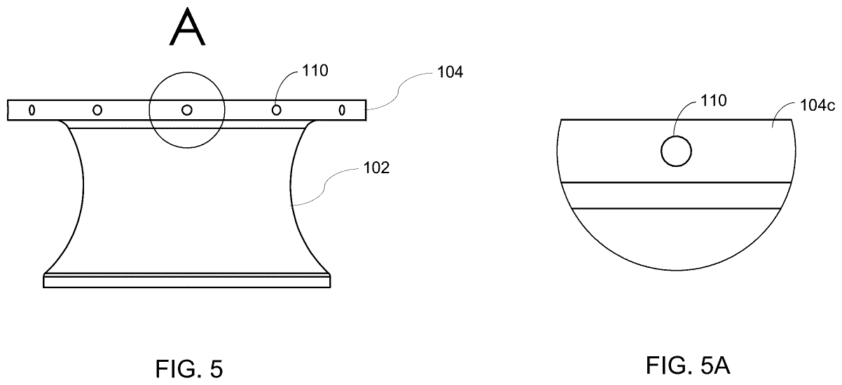

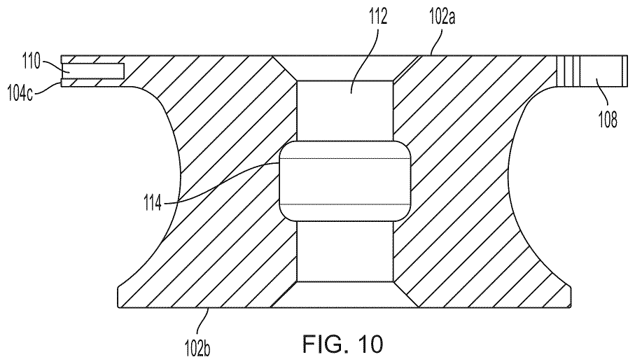

With the first end 12a of the lure anchored by the retention slot 108 and the length of the lure (fishing line or leader) wrapped around the spool 102, the second end 12b of the lure may be anchored to the storage device 100 by engaging one or more of the hooks 16 at the second end 12b of the lure with one or more respective hook captures 110 of the storage device 100. As shown in FIGS. 5, 5A, and 8, a plurality of hook captures 110 are formed and circumferentially spaced apart along the circumferential edge 104c of the flange 104 and configured to receive at least a portion of a hook 16 to secure the second end 12b of the lure at the storage device 100. Each hook capture 110 is a hole or slot or recess protruding partially through the flange along the side surface 104c (FIG. 10). As the lure is wrapped around the spool 102, the tip or end of a hook 16 may engage or be partially received in a hook capture 110 and the tension along the lure retains the lure at the storage device 100. When multiple hooks 16 are disposed at the second end 12b of the lure, each hook 16 may engage a respective hook capture 110 as the lure wraps around the spool 102.

That is, the hook capture 110 may be a hole at the outer edge of the storage device 100 that extends radially toward the longitudinal axis of the spool. The hook capture 110 may have any suitable shape and configuration, such as a circular, oval, or polygonal cross-section. Optionally, the hook capture 110 may be configured to engage and retain a barbed end of the hook, such as by providing a ballooned recess. That is, the inner diameter or perimeter dimension of the hook capture may be greater than the diameter or perimeter dimension at the opening of the hook capture 110. The hook captures are evenly spaced from one another to allow for a variety of different leader lengths. Furthermore, the hook capture 110 acts as a point of termination for the fishing hook 16 to protect the user from the sharp hook and to prevent entanglement of the hook 16 with the rest of the lure or other lures at the storage device or other nearby storage devices. Because of the tapered shape of the spool body 102c, the lure may move along the length of the spool 102 to accommodate different positions of the hook 16 about the circumferential edge 104c of the flange 104.

As shown in FIGS. 2, and 4, the storage device 100 may include a cylindrical channel or passage 112 through the center of the storage device 100 and along the longitudinal axis of the storage device so that the storage device 100 may be mounted or disposed at a peg or post or pin of a mounting rack and rotated relative to the mounting rack about a longitudinal axis of the storage device 100. The cylindrical passage 112 extends through the first end 102a and the second end 102b of the spool 102 so that a plurality of storage devices 100 may be stacked or disposed along the same post of the mounting rack. One or both of the openings of the cylindrical passage 112 (at the respective first and second ends of the spool) may be tapered to allow for easier mounting to the mounting rack. For example, and as shown in FIG. 2, a tapered surface or area 112a extends from the first side 104a of the flange 104 to the cylindrical passage 112 at an oblique angle between the planar first side 104a and longitudinal axis of the passage 112, thus providing a conical opening or mouth to the passage 112. The tapered area 112a may also allow for positive retention when held with fingers, or gloved fingers, while removing the crawler harness from an individual lure storage device 100 that is retained individually in a tackle box.

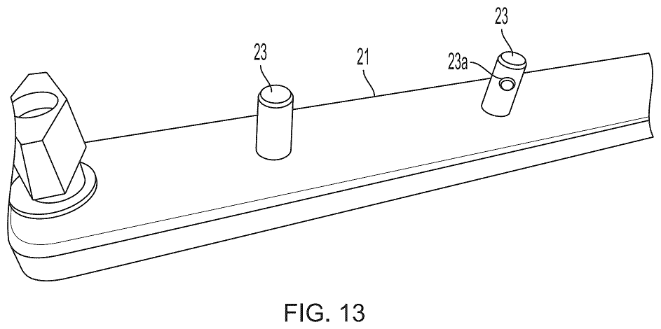

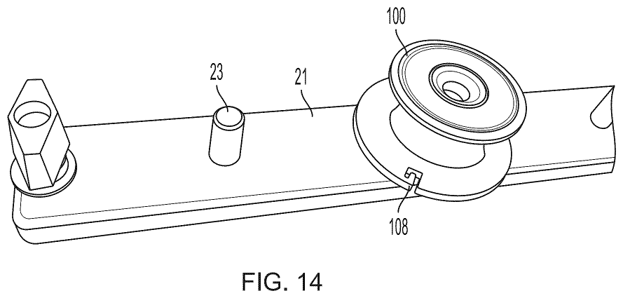

Optionally, and such as shown in FIGS. 10-14, a retention feature or recess 114 may be disposed along the passage 112 between the first end 102a and the second end 102b to engage the peg or post of the mounting rack 21 when the storage device 100 is disposed at the mounting rack 21. In the illustrated example, the retention feature 114 includes a recess or enlarged portion of the passage 112 that is spaced from both the first end 102a and the second end 102b. The retention feature 114 may provide a cylindrical or oval shape or cross-section.

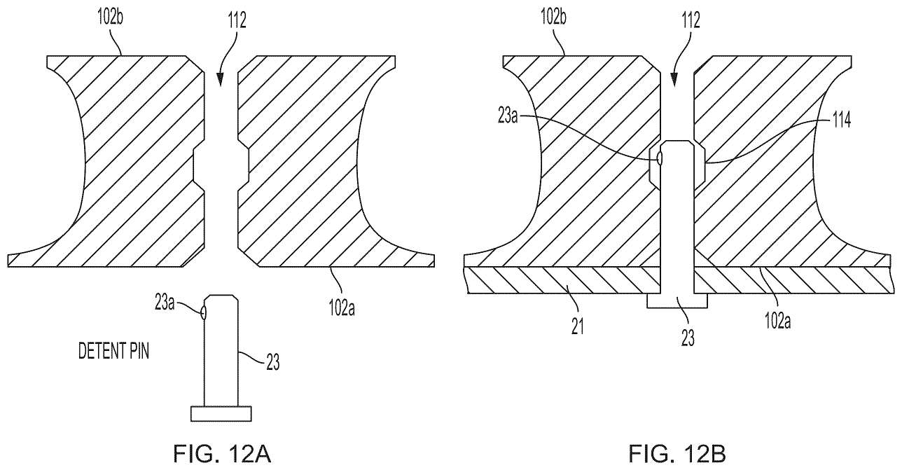

With the retention feature 114 disposed along the passage 112, the storage device 100 may be retained at the mounting rack 21 via a shorter pin or peg 23. For example, the pin or peg 23 may extend a distance from the mounting rack 21 that is less than a length of the passage 112 such that the peg 23 does not extend out of the end of the passage 112 distal from the mounting rack 21. In such an example, the peg 23 may include an engagement feature 23a configured to engage the retention feature 114 to secure the storage device 100 along the peg 23 and to the mounting rack 21. For example, and such as shown in FIGS. 12A, 12B, 13, and 14, the peg 23 may include a compressible protrusion 23a, such as a spring-loaded bead or pin, that compresses as the peg 23 is inserted into the passage 112 and that expands into the retention recess 114 as the storage device slides along the peg 23. That is, the recess allows a spring-loaded element of the detent pin to engage into the recess on the spool to maintain retention of the spool to the mounting plate. When removing the storage device 100 from the mounting rack 21, pulling the storage device 100 compresses the protrusion 23a to allow the peg 23 to slide along the passage 112.

Thus, with the spool retained at the peg 23 and mounting rack 21 via the peg and compressible protrusion, the spool is allowed to spin or rotate about the peg (with the protrusion moving along the recess 114, and the spool is precluded from moving along the peg. In other words, the spool recess is designed to bi-directionally retain the spool in place. When the spool is in place, it is still allowed to freely rotate while being retained at the mounting rack.

Optionally, the passage 112 may not extend the entire length of the storage device 100, such that an opening is only formed at one of the first end 102a or the second end 102b. Including the retention feature 114, and optionally utilizing a peg with an engagement feature, ensures that the storage device 100 is retained along the peg 23 and at the mounting rack or plate or rod without requiring the peg to extend fully through the storage device 100.

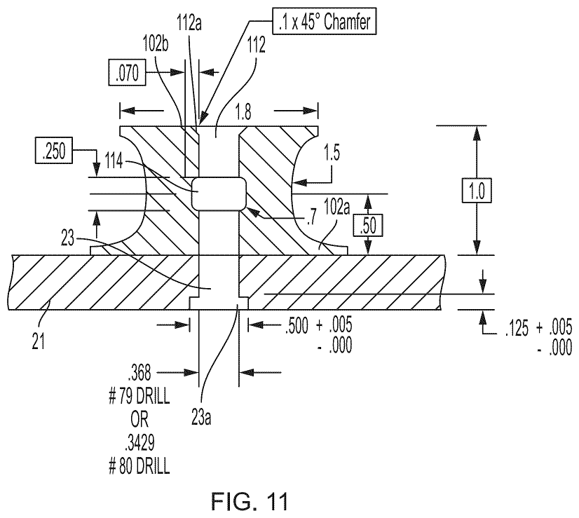

The peg may be integrally formed with the mounting rack 21 or the peg may be fastened to the mounting rack 21, such as via a threaded portion of the peg received in a correspondingly threaded receiver of the mounting rack 21. As shown in FIG. 11, the mounting rack 21 includes a through hole 21a formed through the mounting rack 21 with an enlarged portion or seat of the through hole disposed at a side of the mounting rack 21 opposite the side configured to receive the storage device 100. Thus, a nut or bolt or other suitable fastener may be disposed at the seat to engage a portion of the peg 23 extending through the through hole 21a. The mounting rack 21 may comprise an elongated plate or rod and may have or support a plurality of fasteners or pegs or posts for supporting a plurality of storage devices at or along the mounting rack. Furthermore, the mounting rack and peg may comprise a suitable material to maintain secure engagement at various environmental temperatures. For example, the peg and rack may experience minimal thermal expansion or contraction at environmental temperatures such as ranging between 0 degrees Fahrenheit or less to 70 degrees Fahrenheit or more or 100 degrees Fahrenheit or more.

FIG. 11 depicts example dimensions of the storage device 100 and mounting rack 21 and it should be understood that the storage device 100 and mounting rack 21 may be formed having any suitable measurement. For example, the passage 112 of the storage device 100 and/or the through hole 21a of the mounting rack 21 may have an inner diameter of 0.5 inches with a tolerance of +0.005 inches and −0 inches. The tapered area or chamfer 112a at the second end 102b may have a width of 0.1 inches at 45 degrees. Threads may be formed along the through hole 21a having an inner diameter of 0.0145 inches (such as using a #79 drill bit) or 0.0135 inches (such as using a #80 drill bit). The seat of the through hole 21a may have a depth from the opposite side of the mounting rack 21 of 0.125 inches with a tolerance of +0.005 inches and −0 inches. The retention feature 114 may have a center point that is positioned halfway along the passage 112, such as at 0.5 inches from the first end 102a when the total length of the passage 112 is 1.0 inches. The retention feature 114 may extend from the center point along the longitudinal axis of the storage device 100 a length of 0.25 inches toward the first end 102a and 0.25 inches toward the second end 102b. The retention feature 114 may extend into the passage 112 (i.e., perpendicular to the longitudinal axis) a length of 0.07 inches. That is, a total width or diameter of the retention feature 114 may be 0.614 inches when the diameter of the passage 112 is 0.5 inches, and the length of the retention feature along the longitudinal axis may be 0.5 inches. The retention feature 114 may have a tapered or rounded profile. The storage device 100 may have a total length from the first end 102a to the second end 102b of 1.0 inches or 1.5 inches. An outer diameter of the storage device 100 at the second end 102b may be 1.8 inches and an outer diameter of the storage device 100 at the central, most tapered region may be 1.5 inches. Although shown as positioning the first end 102a against the mounting rack 21, the storage device 100 may be configured to position the second end 102b against the mounting rack 21, and/or configured to have either the first end 102a or second end 102b positioned against or facing the mounting rack 21.

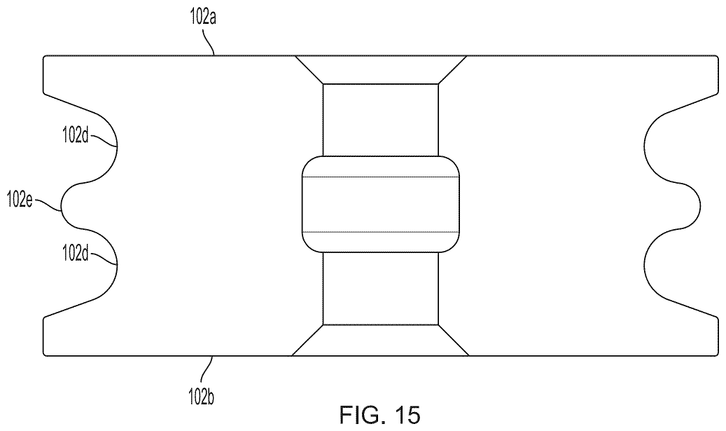

Optionally, and such as shown in FIG. 15, the body or outer surface 102c of the spool 102 may include a plurality of tapered regions so that multiple lures may be retained at the same storage device 100. That is, between the first end 102a and the second end 102b, the diameter of the spool 102 may alternate between thinner regions and wider regions so that lures may be retained about the spool within the thinner regions and separated from one another by the wider regions, which may form separating flanges between tapered regions along the spool 102. As shown in the illustrated example, the spool 102 includes thinner diameter or tapered portions 102d separated by a wider diameter or flange portion 102e so that a first lure may be retained between the flange portion 102e and the first end 102a and a second lure may be retained between the flange portion 102e and the second end 102b.

Thus, the storage device 100 includes a concave, tapered spool 102 having a circular and planar flange 104 extending from a first end of the spool 102. The flange 104 includes a retention slot 108 formed through the flange along a circumferential edge 104c of the flange and a plurality of hook capture holes or slots 110 about the edge 104c of the flange. The first end 12a of the lure may be anchored at the retention slot 108 and the leader or length of the lure is wrapped around the spool 102 of the storage device (such as by rotating the storage device about a post of a mounting rack). With the lure wrapped around the spool 102, the one or more hooks 16 of the lure may be engaged with the one or more hook captures 110 to secure the second end 12b of the lure to the storage device 100. The storage device 100 may store one or more lures about the same spool, or each storage device may be configured to receive only one lure. Thus, the lures may be stored (such as at a mounting rack or in a tackle box) with reduced risk of tangling or damaging the lures.

Changes and modifications in the specifically described embodiments can be carried out without departing from the principles of the invention, which is intended to be limited only by the scope of the appended claims, as interpreted according to the principles of patent law including the doctrine of equivalents.

1. A storage device for a fishing lure, the storage device comprising:
a spool having a longitudinal axis extending between a first end of the spool and a second end of the spool;
a flange extending radially from the spool at the first end, wherein the flange comprises a first side and a second side opposite the first side, and wherein a circumferential edge of the flange extends between the first side and the second side;
wherein a slot extends radially inward from the circumferential edge of the flange and toward the longitudinal axis of the spool;
wherein a hook receiving recess extends radially inward from the circumferential edge of the flange between the first side and the second side;
wherein the slot is configured to receive a leader line of a fishing lure so that a connecting element at a first end of the leader line is disposed at the first side of the flange;
wherein the spool is configured to receive a length of the leader line between the first end of the leader line received at the slot and a second end of the leader line opposite the first end so that the leader line is wrapped about the spool; and
wherein the hook receiving recess is configured to receive a hook at the second end of the leader line to secure the second end of the leader line relative to the spool when the connecting element is disposed at the first side of the flange and the leader line is wrapped about the spool.

2. The storage device of claim 1, wherein the storage device comprises (i) a first outer diameter at the first end of the spool, (ii) a second outer diameter at the second end of the spool, and (iii) a third outer diameter at a central region of the spool between the first end and the second end, and wherein the third outer diameter is less than the first outer diameter and the second outer diameter.

3. The storage device of claim 2, wherein an outer surface of the spool is tapered between the first outer diameter and the third outer diameter and between the second outer diameter and the third outer diameter.

4. The storage device of claim 1, wherein the slot comprises (i) a first portion extending from the circumferential edge of the flange and toward the longitudinal axis of the spool, and (ii) a second return portion extending from the first portion toward the circumferential edge of the flange and away from the longitudinal axis of the spool.

5. The storage device of claim 1, wherein the slot comprises a J-shaped slot.

6. The storage device of claim 1, wherein the hook receiving recess comprises a circle or oval shape.

7. The storage device of claim 1, wherein a plurality of hook receiving recesses extend radially inward from the circumferential edge of the flange between the first side and the second side, and wherein the respective hook receiving recesses of the plurality of hook receiving recesses are disposed at respective discrete circumferentially spaced apart locations about the circumferential edge of the flange.

8. The storage device of claim 7, wherein the respective hook receiving recesses of the plurality of hook receiving recesses are uniformly spaced from one another about the circumferential edge of the flange.

9. The storage device of claim 1, wherein a cylindrical passage extends through the spool and along the longitudinal axis between the first end and the second end of the spool.

10. The storage device of claim 9, wherein a retention feature is disposed along the cylindrical passage between the first end and the second end of the spool, and wherein the retention feature is configured to engage a peg of a mounting rack when the storage device is stored at the mounting rack.

11. The storage device of claim 1, wherein the connecting element engages the first side of the flange to secure the first end of the leader line relative to the spool.

12. A storage device for a fishing lure, the storage device comprising:
a spool having a longitudinal axis extending between a first end of the spool and a second end of the spool;
wherein the spool comprises (i) a first outer diameter at the first end of the spool, (ii) a second outer diameter at the second end of the spool, and (iii) a third outer diameter at a central region of the spool between the first end and the second end, and wherein the third outer diameter is less than the first outer diameter and the second outer diameter
a flange extending radially from the spool at the first end, wherein the flange comprises a first side and a second side opposite the first side, and wherein a circumferential edge of the flange extends between the first side and the second side;
wherein a slot extends radially inward from the circumferential edge of the flange and toward the longitudinal axis of the spool;
wherein a hook receiving recess extends radially inward from the circumferential edge of the flange between the first side and the second side; and
wherein a cylindrical passage extends partially through the spool and along the longitudinal axis from the second end toward the first end of the spool.

13. The storage device of claim 12, wherein an outer surface of the spool is tapered between the first outer diameter and the third outer diameter and between the second outer diameter and the third outer diameter.

14. The storage device of claim 12, wherein the slot comprises (i) a first portion extending from the circumferential edge of the flange and toward the longitudinal axis of the spool, and (ii) a second return portion extending from the first portion toward the circumferential edge of the flange and away from the longitudinal axis of the spool.

15. The storage device of claim 12, wherein a plurality of hook receiving recesses extend radially inward from the circumferential edge of the flange between the first side and the second side, and wherein the respective hook receiving recesses of the plurality of hook receiving recesses are disposed at respective discrete circumferentially spaced apart locations about the circumferential edge of the flange.

16. The storage device of claim 12, wherein a retention feature is disposed along the cylindrical passage, and wherein the retention feature is configured to engage a peg of a mounting rack when the storage device is stored at the mounting rack.

17. The storage device of claim 12, wherein the slot is configured to receive a leader line of a fishing lure so that a connecting element at a first end of the leader line is disposed at the first side of the flange, and wherein the spool is configured to receive a length of the leader line between the first end of the leader line received at the slot and a second end of the leader line opposite the first end so that the leader line is wrapped about the spool, and wherein the hook receiving recess is configured to receive a hook at the second end of the leader line to secure the second end of the leader line relative to the spool when the connecting element is disposed at the first side of the flange and the leader line is wrapped about the spool.

18. A storage system for a fishing lure, the storage system comprising:
a mounting rack comprising a plate and a peg extending from the plate;
a storage device configured to retain a fishing lure disposed thereat, wherein, when the storage device is stored at the mounting rack, the storage device is rotatably disposed along the peg of the mounting rack;
wherein the storage device comprises a spool having a longitudinal axis extending between a first end of the spool and a second end of the spool;
wherein a flange extends radially from the spool at the first end, wherein the flange comprises a first side and a second side opposite the first side, and wherein a circumferential edge of the flange extends between the first side and the second side;
wherein a slot extends radially inward from the circumferential edge of the flange and toward the longitudinal axis of the spool;
wherein a hook receiving recess extends radially inward from the circumferential edge of the flange between the first side and the second side;
wherein a cylindrical passage extends through the spool and along the longitudinal axis between the first end and the second end of the spool, and wherein the peg is received along the cylindrical passage to store the storage device at the mounting rack;
wherein, when the fishing lure is disposed at the storage device, the slot receives a leader line of the fishing lure so that a connecting element at a first end of the leader line is disposed at the first side of the flange;
wherein, when the fishing lure is disposed at the storage device, the spool is configured to receive a length of the leader line between the first end of the leader line received at the slot and a second end of the leader line opposite the first end so that the leader line is wrapped about the spool; and
wherein the hook receiving recess is configured to receive a hook at the second end of the leader line to secure the second end of the leader line relative to the spool when the connecting element is disposed at the first side of the flange and the leader line is wrapped about the spool.

19. The storage system of claim 18, wherein a retention feature is disposed along the cylindrical passage between the first end and the second end of the spool, and wherein the peg comprises a compressible protrusion that (i) compresses as the peg is moved along the cylindrical passage and the compressible protrusion moves along the cylindrical passage toward the retention feature, and (ii) expands when the compressible protrusion is at the retention feature to secure the storage device along the peg.

20. The storage system of claim 18, wherein the storage device comprises (i) a first outer diameter at the first end of the spool, (ii) a second outer diameter at the second end of the spool, and (iii) a third outer diameter at a central region of the spool between the first end and the second end, and wherein the third outer diameter is less than the first outer diameter and the second outer diameter.
